(19) United States
(12) Patent Application Publication
(10) Pub. No.: US 2020/0251950 A1
(43) Pub. Date: Aug. 6, 2020

(54) WINDING OF A GENERATOR OF A WIND POWER INSTALLATION, AND METHOD FOR CONNECTING FLAT RIBBON CONDUCTORS

(71) Applicant: Wobben Properties GmbH, Aurich (DE)

(72) Inventors: Jochen RÖER, Ganderkesee (DE); Gerald MÖHLMANN, Rhauderfehn (DE)

(21) Appl. No.: 16/305,796

(22) PCT Filed: May 16, 2017
(86) PCT No.: PCT/EP2017/061688

§ 371 Date: Nov. 29, 2018

(30) Foreign Application Priority Data
Jun. 8, 2016 (DE) 10 2016 110 533.3

(51) Int. Cl. H02K 3/52; H02K 7/18; H02K 15/00; H02K 3/18; H02K 3/28

(52) U.S. Cl. CPC H02K 3/527; H02K 7/1838; H02K 3/28; H02K 3/18; H02K 15/0081

(57) ABSTRACT

A winding of a generator of a wind power installation, in particular of the rotor. The winding comprises a plurality of coils which are each wound using a flat ribbon conductor, wherein the flat ribbon conductors have in each case two ends and at least two flat ribbon conductors are connected to one another. The flat ribbon conductors, in each case viewed from the respective end, are incised or punched at least up to a predefined length of the flat ribbon conductor in the longitudinal direction, such that at least two part-end pieces of the flat ribbon conductor which have in each case a substantially identical width are created. The part-end pieces herein are bent in such a manner that the part-end pieces overlap at least in a connection region, wherein the connection regions of two ends overlap in a common connection region and are connected there. Also provided is a method for producing such a winding.

### BACKGROUND

### Technical Field

The invention relates to the winding of a generator of a wind power installation, and to a method for producing connections of flat ribbon cables which are preferably used for the winding.

### Description of the Related Art

Wind power installations, in particular also gearless wind power installations, according to the prior art are known. Wind power installations are driven by an aerodynamic rotor which is connected directly to a rotor of a generator. The kinetic energy harvested from the wind is converted into electrical energy by the movement of the rotor in the generator. The rotor of the generator accordingly rotates at the same slow rotational speed as the aerodynamic rotor.

In order for such a slow rotational speed to be considered, the generator has a generator diameter that is comparatively large in relation to the nominal output, said diameter preferably being several meters and having a large air gap diameter. The air gap is limited to the side of the rotor by rotor poles having pole packs. The pole packs are composed of a block of material or of a multiplicity of punched pole pack plates which are layered on top of one another and, for example, are welded to one another so as to form the pole packs.

According to the prior art the pole pack plates of the pole packs have a pole shank region and a pole head region. The pole packs are provided with a winding which can also be referred to as the rotor winding, and an electrical exciter current is supplied to said winding. On account thereof, a magnetic excitation is created by way of the pole packs and the corresponding windings conjointly with the exciter current. Said magnetic excitation leads to the pole packs, conjointly with the winding, serving as magnetic poles of the rotor of the generator, in particular of a synchronous generator.

In manufacturing, a plurality of windings, preferably from aluminum flat wire or copper flat wire, are wound around the pole shank of each pole pack, and on account thereof form a coil. The ends of a plurality of coils are connected to one another so as to establish respective poles of the generator by way of simultaneous energizing. Conductors from aluminum flat wire or copper flat wire can also generally be referred to collectively using the term flat ribbon conductor or flat wire conductor.

Apart from the pole winding from flat wire, there are also windings from flat ribbon. In order for flat ribbon coils to be connected, the cold pressure welding method is used as standard.

This means that the flat ribbon conductor, which in the wound state forms the coil which can also be referred to as the flat ribbon coil, across the entire width of said flat ribbon conductor is brought into contact with a flat rod and is connected to the rod at a plurality of locations by cold pressure welding. A plurality of connections per end of a flat ribbon coil are required in order for a sufficiently low resistance of the connection to be guaranteed such that no excessive heat which destroys the connection is created in the connection region.

Cold pressure welding connections are performed under high pressure and below the crystallization temperature of the individual parts. This connection method is thus particularly advantageous since no high temperatures are required in order for a form-fitting connection to be established, as is the case in welding, for example.

However, the quality of the bonding depends on the careful pre-treatment of the contact points, and a complex preparation is thus required for the connection. Moreover, testing the quality of the bonding is directly necessary upon producing the latter since the bonding in the case of a connection established by cold pressure welding has comparatively often not been established at a sufficient quality. Reworking in the case of poor bonding, for example after completion of a generator, is very difficult. For example, the beginning of a coil when being wound is covered by a subsequent winding and is therefore no longer accessible for later checking.

Welded connections in which a large amount of heat that is difficult to limit to a predefined connection region is required are not suitable for connecting the flat ribbon cables or coils from flat ribbon, since the heat generated can lead to the destruction of components which lie in the surrounding region of a connection region, for example.

A possibility for connecting two flat ribbon cables is desired, said connection being of high quality and being achievable with less preliminary work, and being capable of being established without heating by a combustible gas, such as the case when welding, for example.

The German Patent and Trademark Office in the priority application to the present application has searched the following prior art: DE 41 26 019 A1, DE 10 2012 208 550 A1, AT 84635 B, U.S. Pat. No. 3,467,931 A, and EP 2 863 402 A1.

### BRIEF SUMMARY

Provided is a winding of a generator of a wind power installation which is produced using flat ribbon coils from flat ribbon cables is proposed. The winding is preferably the winding of the electric rotor of the generator. Each of the flat ribbon conductors which is wound to form a flat ribbon coil has two ends. The flat ribbon conductor extends in a length, is preferably made from copper or aluminum, and has a cross section. The cross section of the flat ribbon conductor herein has a height which is substantially smaller than the width. The width thus corresponds to at least ten times the height.

At least two ends of two different flat ribbon conductors are furthermore connected. To this end, the ends, in each case viewed from the respective end are incised or punched at least up to a predefined length in the longitudinal direction, such that at least two part-end pieces of the flat ribbon conductor are created at the end of the flat ribbon conductor. The part-end pieces have in each case a substantially identical width. Moreover, the part-end pieces are bent in such a manner that the part-end pieces overlap at least in a connection region. A breakthrough through all part-end pieces of both connection regions of the two ends is preferably provided in the overlapping connection regions of both ends that are disposed so as to overlap in a common connection region, wherein the part-end pieces of both ends are connected to one another, in particular by means of the breakthrough, in common connection regions.

Accordingly, the connection regions of the ends can be connected by a single common connection region, for example by way of the breakthrough which can be riveted, screw-fitted, or used for a connection in any other manner. A sufficiently low resistance is moreover guaranteed by overlapping and physical contacting of the part-end pieces in the common connection region. Multiple connecting as in the case of cold pressure welding is thus not required.

According to a first embodiment, the part-end pieces of the first end of a flat ribbon conductor and the part-end pieces of the second end of a second flat ribbon conductor are disposed so as to overlap in the common connection region such that a part-end piece of the respective other end is in each case disposed between two part-end pieces of the first end.

A particularly advantageous electrical conduction having a low resistance from one end of a flat ribbon conductor to the other end of another flat ribbon conductor is thus possible. The contact region, on account of the part-end pieces of different ends that are disposed in an alternating manner, thus the stacked arrangement, is chosen so as to be as large as possible.

According to a further embodiment all part-end pieces are bent such that the part-end pieces overlap in a connection region in that each part-end piece has a bending angle of 180 degrees. The bending line herein in relation to the longitudinal axis has an angle of more than 0, such that the connection region is located so as to be laterally next to the flat ribbon conductor. The part-end pieces are thus laterally folded back. A connection region has been established in a particularly simple manner on account of this bending of the part-end pieces, specifically on account of the part-end pieces being folded back in an oblique manner. A bending angle of 180 degrees can be simply and precisely produced.

According to a further embodiment the bending line of the part-end pieces in relation to a longitudinal axis of the part-end pieces has an angle of 45 degrees such that the part-end pieces run at an angle of 90 degrees, that is to say the longitudinal axis of the part-end pieces has in each case a rectangular profile, and said part-end pieces are bent at a bending angle of 180 degrees. Connections in particular for connecting neighboring flat ribbon conductors can consequently be established by establishing the common connection regions between the neighboring flat ribbon conductors, without using further materials such as the rods or connecting rods used according to the prior art. Accordingly, the part-end pieces per se replace the connecting rods. Moreover, the connection of two flat ribbon conductor ends, and thus the connection of two neighboring coils, is thus possible by producing a single connection.

According to a further embodiment a breakthrough through the part-end pieces in the common connection region is produced by drilling or punching. The part-end pieces of both ends in this instance are screw-fitted by a screw through the common breakthrough.

According to an alternative embodiment of the last-mentioned embodiment the breakthrough has been produced in that the part-end pieces in the connection region have at least partially been brought into mutual contact and a rotating bladeless tool has been advanced through the workpieces to be connected in the common connection region during the rotation in the axial direction.

A bladeless drill bit which preferably is a flow drill bit has been used for producing the breakthrough. The tool liquefies the material of the part-end pieces on account of the friction when in contact with the part-end pieces, such that said part-end pieces are connected to one another when the material of the part-end pieces solidifies after the tool has been removed from the breakthrough.

A connection of this type has the advantage that the heat required for fusing the material of the part-end pieces, thus the aluminum and/or copper, is produced directly by the friction in the connection region. Neighboring components are thus not exposed to collateral damage by a flame such as is required when welding, for example. On account thereof, no conventional welding method, for example gas-shielded welding method, has to be used for the connection.

Provided is a method for connecting flat ribbon conductors, wherein two ends of two flat ribbon conductors are connected by the following steps. Preferably, the flat ribbon conductors have previously been wound about the rotor pole shanks of a rotor of a wind power installation. First, each flat ribbon conductor is incised once or multiple times in each case at the end up to at least a predefined length in the longitudinal direction of the conductor such that at least two, preferably at least six or at least eight, part-end pieces having in each case a substantially identical width are created. The part-end pieces accordingly have the same thickness as the flat ribbon conductor per se. Thereafter, the part-end pieces are bent in such a manner that said part-end pieces overlap in an alternating manner at least in a connection region. Accordingly, each flat ribbon conductor has a connection region. The connection regions of two flat ribbon conductors are then disposed so as to overlap in a common connection region. A breakthrough which leads through all part-end pieces of both ends is then preferably produced in the common connection region.

The breakthrough serves for connecting the part-end pieces.

According to one embodiment of the method the breakthrough is produced in that a bladeless rotating tool is advanced through all part-end pieces while the material of the part-end pieces is liquefied on account of the friction between the material of the part-end pieces and the tool. A materially integral connection is created by solidification after the tool has been removed.

### BRIEF DESCRIPTION OF THE SEVERAL VIEWS OF THE DRAWINGS

Further embodiments are derived by means of the exemplary embodiments that are explained in more detail in the figures in which:

FIG. 1 shows a wind power installation;

FIG. 2 shows a schematic lateral view of a generator;

FIG. 3 shows a flat ribbon cable which is connected to cold-welded flat rods (prior art);

FIG. 4 shows a flat ribbon cable having bent-back part-end pieces;

FIG. 5 shows two flat ribbon cables having connected ends; and

FIG. 6 shows a breakthrough in the common connection region by way of which the part-end pieces of two ends are connected.

### DETAILED DESCRIPTION

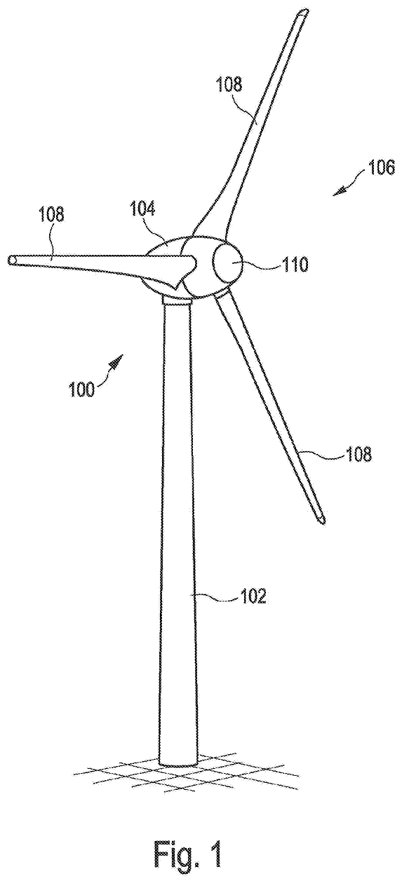

FIG. 1 shows a schematic illustration of a wind power installation 100 according to the invention. The wind power installation 100 has a tower 102 and a gondola 104 on the tower 102. An aerodynamic rotor 106 having three rotor blades 108 and a spinner 110 is provided on the gondola 104. The aerodynamic rotor 106 in the operation of the wind power installation is set in rotational motion by the wind and thus also rotates a rotor of a generator which is coupled directly or indirectly to the aerodynamic rotor 106. The electric generator is disposed in the gondola 104 and generates electrical energy. The pitch angles of the rotor blades 108 can be modified by pitch motors on the rotor blade roots 108b of the respective rotor blades 108.

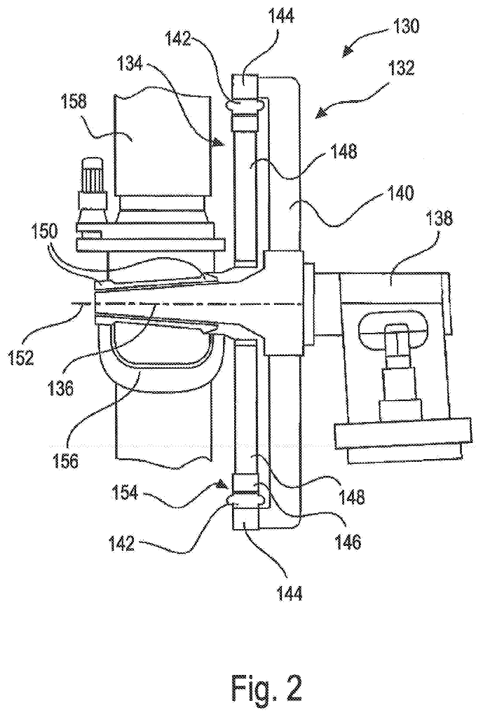

FIG. 2 schematically shows a generator 130 in a lateral view. Said generator 130 has a stator 132 and an electrodynamic rotor 134 that is mounted so as to be rotatable in relation to said stator 132, and said generator 130 by way of the stator 132 thereof via an axle journal 136 is fastened to a machine support 138. The stator 132 has a stator support 140 and bundles of stator laminations 142 which form stator poles of the generator 130 and are fastened to the stator support 140 by way of a stator ring 144.

The electrodynamic rotor 134 has rotor poles 146 which by way of a rotor support 148, which can also be referred to as yoke or rotor yoke, and bearings 150 on the axle journal 136, are mounted so as to be rotatable about the rotational axis 152. The bundles of stator laminations 142 and rotor poles 146 are separated only by a narrow air gap 154 which has a thickness of a few millimeters, in particular of less than 6 mm, but has a diameter of several meters, in particular of more than 4 m.

The bundle of stator laminations 142 and the rotor poles 146 form in each case a ring and conjointly are also annular such that the generator 130 is a ring generator. In the intended use, the electrodynamic rotor 134 of the generator 130 rotates conjointly with the rotor hub 156 of the aerodynamic rotor 106 of which fragments of rotor blades 158 are indicated.

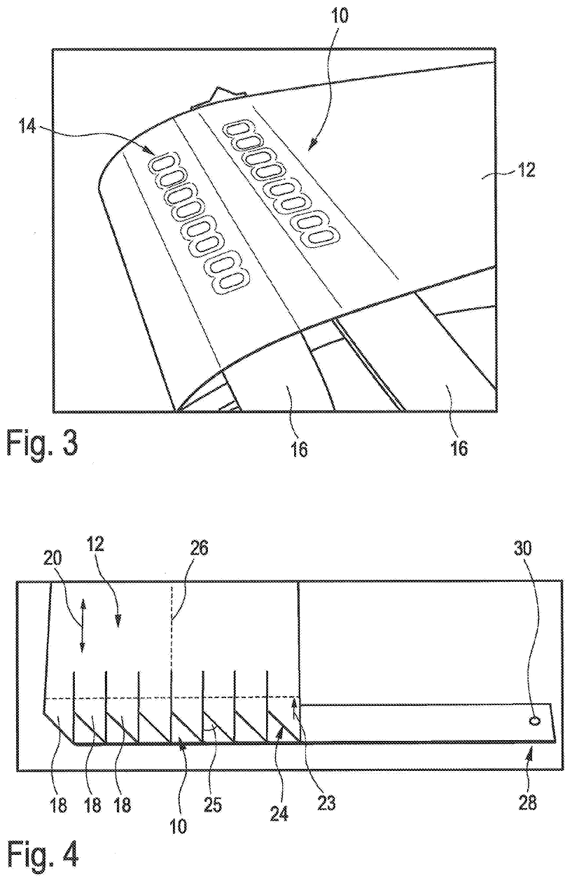

FIG. 3 shows an end 10 of a flat ribbon conductor 12 from which the winding of the rotor 134 can be formed as coil that is wound in the rotor 134 conjointly with further flat ribbon conductors 12 that are wound as coil. The flat ribbon conductor 12 in a connection region 14 is connected to two rods or flat rods 16 by cold pressure welding. The flat rods 16 lead to a further end 10 of a further flat ribbon conductor 12 (not illustrated here), said further end 10 likewise being connected to the flat rods 16 by cold pressure welding. This connection is known from the prior art.

As opposed to the prior art, FIG. 4 shows an end 10 of a flat ribbon conductor 12 which has a plurality of part-end pieces 18, specifically exactly eight part-end pieces 18. The part-end pieces 18 have been produced in that the flat ribbon conductor 12 has been incised multiple times in the longitudinal direction 20 of said flat ribbon conductor 12. The cuts 22 are disposed between the part-end pieces 18 and protrude at least up to a length 23 of the flat ribbon conductor 12, as seen from the end 10. Presently, seven cuts or incisions 22 have been performed in order for the eight part-end pieces 18 to be obtained.

The part-end pieces 18 have now been bent back in each case by 180 degrees along a bending line 24. The bending line 24 herein in relation to the longitudinal axis 26 of the end 10 of the conductor 12 has an angle 25 of substantially 45 degrees. The part-end pieces 18 overlap in a connection region 28, wherein individual part-end pieces 18 that protrude beyond the connection region 28 have been severed. A breakthrough 30 has been produced in the connection region 28 in order for the flat ribbon conductor 12 to be connected to a further flat ribbon conductor 12.

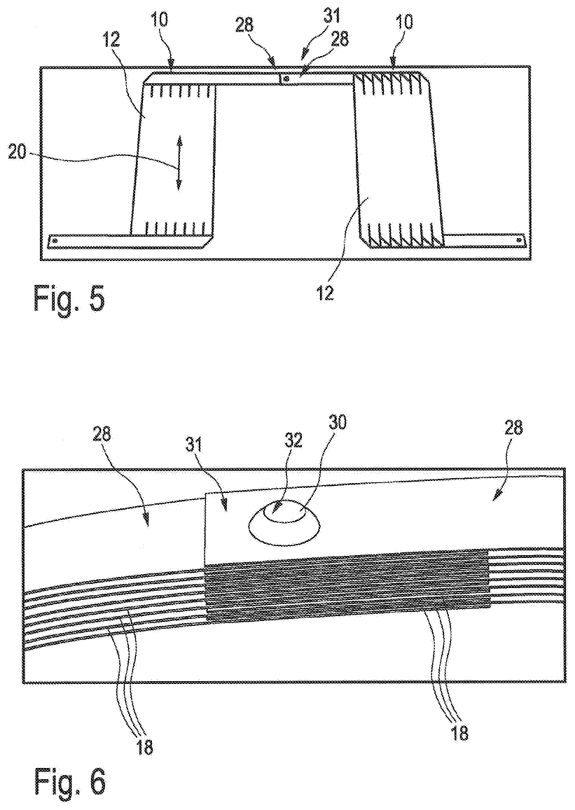

FIG. 5 shows two flat ribbon conductors 12 in a schematic illustration, said flat ribbon conductors 12 in the longitudinal direction 20 extending substantially to a lesser length than the flat ribbon conductors 12 which are wound as a coil around a pole pack of a rotor pole 146. The illustration is presently illustrated only in order for the connection of the flat ribbon conductors 12 to be schematically illustrated. The flat ribbon conductors 12 have a common connection region 31 in which said flat ribbon conductors 12 are connected to one another. The common connection region 31 is formed by the overlapping arrangement of two connection regions 28 as illustrated in FIG. 4 with the view to a single flat ribbon conductor 12. Both ends 10 are incised and bent back in the upper portion, as is illustrated in an enlarged manner in FIG. 4. The common connection region 31 is moreover illustrated in an enlarged manner in FIG. 6.

FIG. 6 shows that the part-end pieces 18 of the respective connection regions 28 of two flat ribbon conductors 12 are stacked on top of one another in an alternating manner in the common connection region 31. The part-end pieces 18 are then connected in the common connection region 31 in that a breakthrough 30, specifically a hole, has been produced in that a rotating bladeless drill bit has been advanced through all part-end pieces 18 in the connection region 28. The material of the part-end pieces 18 herein has been liquefied, and the material of the different part-end pieces 18 on account of the liquefaction has flown into one another. A breakthrough 30 remains once the bladeless drill bit has been removed, and the part-end pieces 18 on the periphery 32 of the breakthrough 30 are connected to one another.

Additionally, according to a further exemplary embodiment (not illustrated here) a screw could also be pushed through the breakthrough 30 and be secured with a nut so as to further secure in mechanical terms the form-fitting connection established here.

For example, the generator of a wind power installation has a nominal output of >1 MW, a diameter of >3 m, and/or a weight of >5 t.

1. A winding of a generator of a wind power installation, wherein the winding comprising:
a plurality of coils, each wound using a flat ribbon conductor, wherein each of the flat ribbon conductors have two ends, wherein at least two ends of two different flat ribbon conductors are connected to one another by a connection,
wherein the connection is established in that ends the flat ribbon conductors are incised or punched at least up to a predefined length of the flat ribbon conductor in the longitudinal direction, such that part-end pieces of the flat ribbon conductor each have a substantially identical width, and the part-end pieces are bent in such a manner that the part-end pieces of the same flat ribbon conductor overlap at least in a connection region, wherein the connection regions of the connected ends overlap in a common connection region.

2. The winding as claimed in claim 1, wherein the part-end pieces of a first end of a first flat ribbon conductor and the part-end pieces of a second end of a second flat ribbon conductor are disposed so as to overlap in the common connection region such that a part-end piece of the respective other end is in each case disposed between two part-end pieces of the first end.

3. The winding as claimed in claim 1, wherein the part-end pieces of an end of a flat ribbon conductor are bent in that each part-end piece has a bending angle of 180 degrees, and the bending line in relation to a longitudinal axis has an angle that is greater than 0 degrees, such that the connection region is located so as to be laterally next to the flat ribbon conductor.

4. The winding as claimed in claim 3, wherein the bending line of the part-end pieces in relation to the longitudinal axis of the part-end pieces has an angle of 45 degrees such that the part-end pieces run at an angle of 90 degrees.

5. The winding as claimed in claim 1, wherein a breakthrough through all part-end pieces in the common connection region is produced by drilling or punching, and the part-end pieces of both ends are screw-fitted by a screw through the breakthrough.

6. The winding as claimed in claim 1, wherein a breakthrough through all part-end pieces in the common connection region has been produced in that the part-end pieces in the common connection region have at least partially been brought into mutual contact and a rotating bladeless tool has been advanced through all part-end pieces to be connected in the common connection region during a rotation in an axial direction.

7. A wind power installation generator having at least one winding as claimed in claim 1.

8. A method for connecting two ends of first and second flat ribbon conductors comprising:
incising or punching the first and second flat ribbon conductors, at least up to a predefined length of the first and second flat ribbon conductors in a longitudinal direction such that at least two part-end pieces of each of the first and second flat ribbon conductors have substantially identical widths;
bending the part-end pieces in such a manner that the part-end pieces of the same flat ribbon conductor overlap at least in a connection region;
disposing the connection regions of two ends in a common connection region; and
connecting the part-end pieces in the common connection region.

9. The method as claimed in claim 8, wherein the part-end pieces of the first end of a first flat ribbon conductor and the part-end pieces of the second end of a second flat ribbon conductor are disposed so as to overlap in the common connection region such that a part-end piece of the respective other end is in each case disposed between two part-end pieces of the first end.

10. The method as claimed in claim 8, wherein the part-end pieces of an end of a flat ribbon conductor are bent in that each part-end piece is bent at a bending angle of 180 degrees, and the bending line in relation to the longitudinal axis has an angle of more than 0 degrees such that the connection region is formed so as to be laterally next to the flat ribbon conductor.

11. The method as claimed in claim 10, wherein the bending line of the part-end pieces in relation to a longitudinal axis of the part-end pieces has an angle of 45 degrees such that the part-end pieces run at an angle of 90 degrees.

12. The method as claimed in claim 8, wherein a breakthrough through all part-end pieces in the common connection region is produced by drilling or punching, and the part-end pieces of both ends are screw-fitted by a screw through the breakthrough.

13. The method as claimed in claim 8, wherein a breakthrough through all part-end pieces in the common connection region is produced in that all part-end pieces in the common connection region are at least partially brought into mutual contact and a rotating bladeless tool is advanced through the part-end pieces to be connected in the common connection region during a rotation in an axial direction.

14. The wind power installation generator of claim 7, wherein the at least one winding is on a rotor of the generator.
